(19) United States
(12) Patent Application Publication
(10) Pub. No.: US 2005/0033772 A1
(43) Pub. Date: Feb. 10, 2005

(54) Real time escalation

(76) Inventors: Charles E. Atchison, Alpharetta, GA (US); Michelle L. Randolph, McDonough, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/909,820

(22) Filed: Aug. 2, 2004

Related U.S. Application Data
(60) Provisional application No. 60/492,552, filed on Aug. 5, 2003.

(51) Int. Cl. G06F 17/00

(52) U.S. Cl. 707/104.1

(57) ABSTRACT

A real time record escalation system creates, maintains, tracks, and forwards escalation records based on records representing user requests collected from individual user workstations. The user request records are collected, and escalation records are created, maintained, tracked, and forwarded, and modify without downloading or installing a client onto the individual work stations.

### CROSS-REFERENCE TO RELATED APPLICATION

This application claims priority to copending U.S. provisional application entitled, “BREW” having Ser. No. 60/492,552, filed Aug. 5, 2003, which is entirely incorporated herein by reference.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present disclosure is generally related to software for computers and, more particularly, is related to the real time escalation of records.

### BACKGROUND

The use of telephone systems has grown exponentially over recent years. Subscribers are utilizing wireless telephones, wireline telephones, facsimile machines, personal computers, and pagers, among other devices, to place telephone voice and/or data calls. As a result of these telephone calls, telecommunications networks process billions of subscriber transactions for thousands of customers. With all of these customers, there are inevitably many customer service requests (CSRs). The telecommunications companies correlate these requests to respective subscriber records for prompt handling. In some instances, a request cannot be handled expeditiously, and the telecommunications companies escalate the request to a member of a service team who is more qualified to handle it. Many CSRs can arise in a month, and the voluminous quantity of requests requires investigation by personnel responsible for resolving any service difficulties. Quickly resolving a CSR increases the likelihood of the telecommunications company receiving satisfactory customer perception and an increase in market share in the highly competitive telecommunications industry.

Often, handling of the CSR involves escalating the request until resolution. Typically, escalating a request requires personnel to contact numerous individuals and organizations, and access several systems to resolve the CSR. The escalation may take place over several hours, days, weeks or months. During the escalation process, personnel keep track of the progress of the resolution of the CSR. Currently, tracking escalations involves utilizing manual processes, such as preparing handwritten notes, rudimentary spreadsheets, or making mental notes of the status of the customer service issue.

Some automated solutions have been developed. However, they require a client service package to be downloaded and installed to each of the users' or customers' systems. Typically, personnel involved in these functions are organized in customer service centers and handle many CSRs per month. Managing the escalation process, including supervising personnel and tracking the progress of a large volume of CSRs, quickly becomes unmanageable when the escalation process involves utilizing manual processes. It is burdensome to request a customer to download and install a software package onto his or her system, especially with the numerous, potentially harmful viruses that computer users are faced with every day. Many computer users are wary of downloading software from anyone, even people and companies that are well known to them for fear of introducing a virus onto their computer system. A record escalation system that forces a user to download and install a software client is becoming impractical. Thus, a heretofore unaddressed need exists in the industry to address the aforementioned deficiencies and inadequacies.

### SUMMARY

Exemplary embodiments of the present disclosure provide a system and method for a real time record escalation system.

Briefly described, in architecture, one embodiment of the system, among others, can be implemented as follows: an interface for receiving records representing user requests collected from one or more individual workstations; at least one database containing data related to user requests; and a processing device configured for creating, maintaining, tracking, and forwarding escalation records based on the received records representing user requests and the data contained in the database related to user requests wherein the processing device creates, maintains, tracks, and forwards escalation records using a generic application on individual workstations.

Exemplary embodiments of the present disclosure can also be viewed as providing methods for escalating records in a generic internet architecture. In this regard, one embodiment of such a method, among others, can be broadly summarized by the following steps: receiving records in a database, the records representing user requests collected from one or more individual workstations; creating escalation records based on the received records representing user requests; maintaining the escalation records; tracking the escalation records, and forwarding the escalation records; wherein the steps of creating, maintaining, tracking, and forwarding are performed with generic applications on the individual workstations.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram depicting an exemplary embodiment of a escalation tracking system.

FIG. 2A is a block diagram depicting how a database is conventionally accessed across a network.

FIG. 2B is a block diagram depicting how a database is accessed across a network in the escalation system without client software on individual workstations, according to exemplary embodiment.

FIG. 3 is a block diagram depicting an exemplary embodiment of a computing device that can be used to implement an exemplary embodiment of an escalation tracking system.

FIG. 4 is a block diagram depicting an exemplary embodiment of a display of a main menu of a escalation tracking system.

FIG. 5 is a diagram depicting an exemplary embodiment of a display of a form to submit a new escalation.

FIG. 6 is a diagram depicting an exemplary embodiment of a display for viewing open escalations.

FIG. 7 is a diagram depicting an exemplary embodiment of a display showing a drop menu system and the options for viewing an escalation record.

FIG. 8 is a diagram depicting an exemplary embodiment of a display of a screen for searching records in an escalation tracking system.

FIG. 9 is a diagram depicting an exemplary embodiment of a display of the detail record report and the escalation options.

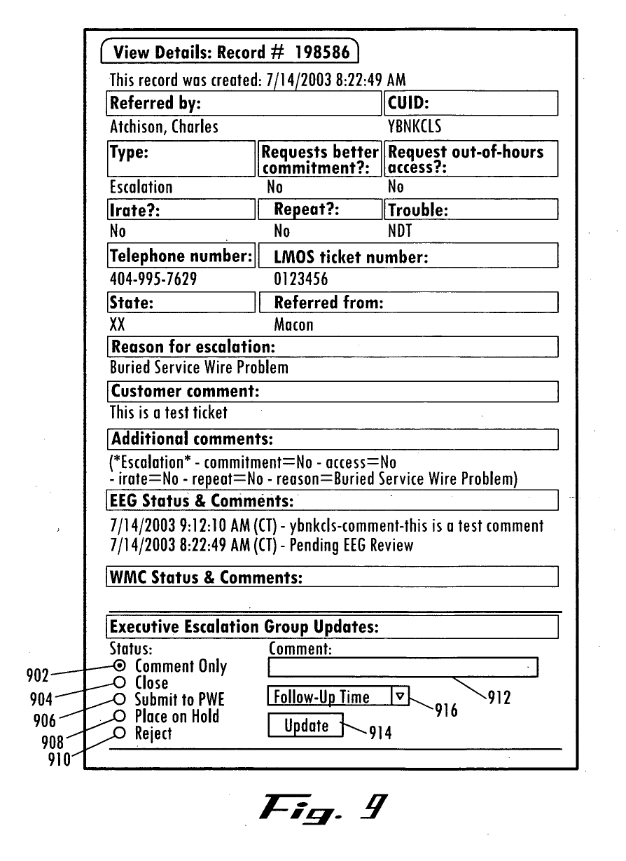

FIG. 10 is a diagram depicting an exemplary embodiment of a display of the initial options available in the escalation tracking system.

FIG. 11 is a flow diagram depicting an exemplary embodiment demonstrating how a customer service issue is addressed in the escalation system.

### DETAILED DESCRIPTION

Disclosed herein are exemplary systems and methods for providing an escalation tracking system. To facilitate description of the inventive systems, an example system that can be used to implement the systems and methods for providing an escalation tracking system is discussed with reference to the figures. Although this system is described in detail, it will be appreciated that this system is provided for purposes of illustration only and that various modifications are feasible without departing from the inventive concept. After the example system has been described, an example of the operation of the system will be provided to explain the manner in which the system can be used to provide an escalation tracking system. The scope of the disclosure includes escalation systems outside the customer service and telecom contexts, i.e., other environments needing management of complaints or other types of escalations.

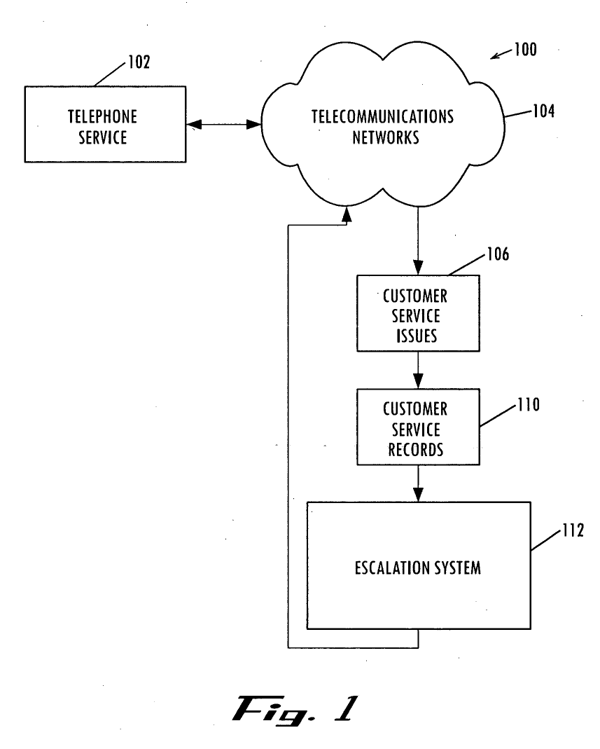

Referring now in more detail to the drawings, in which like numerals indicate corresponding parts throughout the several views, FIG. 1 is a block diagram depicting an exemplary embodiment of an escalation tracking system 100 in a telecommunications customer service context. A customer of a telecommunications service provider utilizes telephony devices, such as a telephone, computer, facsimile machine, wireless device, among others, to provide telephone service 102 that traverses the telecommunications network 104. The telecommunications network 104 may be any type of communication network employing any network topology, transmission medium, or network protocol. For example, such a network may be any public or private packet-switched or other data network, including the internet, circuit-switched network, such as the public switched telecommunications network (PSTN), wireless network, or any other desired communications infrastructure and/or combination of infrastructures. In an exemplary embodiment, telephone service is provided by equipment, such as equipment associated with a telecommunications switch in the telecommunications network 104. Customer service issues 106 occur related to the equipment in telecommunications network 104. Customer service issues 106 include cannot call out, cannot be called, no dial tone, and static on phone lines, among others.

In some cases, an issue occurs in providing the telecommunications service, and a customer service issue record 110 is generated from the customer service issue 106. The customer service record 110 may require handling on an exception basis to obtain resolution. In one embodiment, the customer service record 110 is sent to an escalation system 112 for investigation, tracking, and resolution of customer service issues 106. The escalation system 112 couples to the telecommunications network 104 such that a user of the system 112 can send electronic mail messages to other personnel.

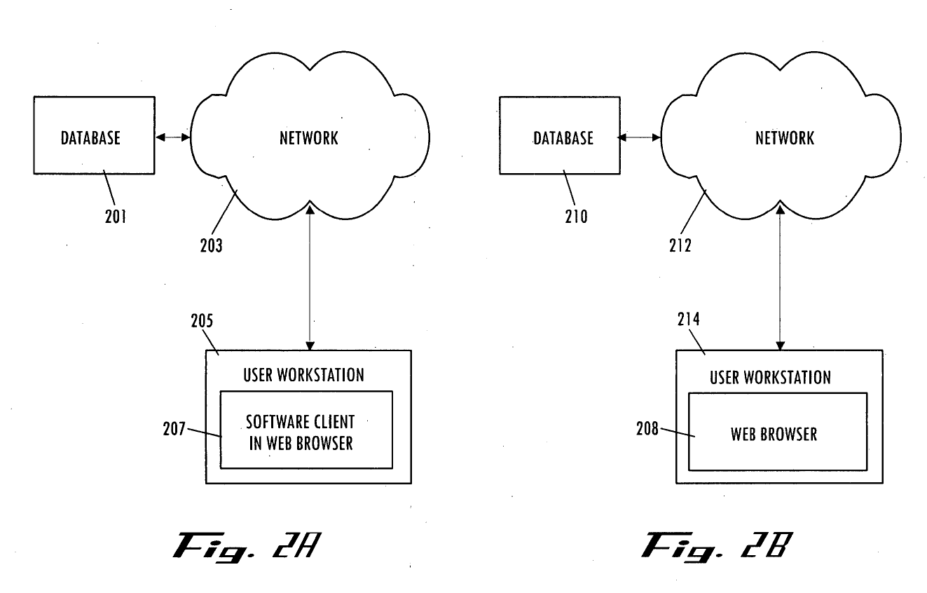

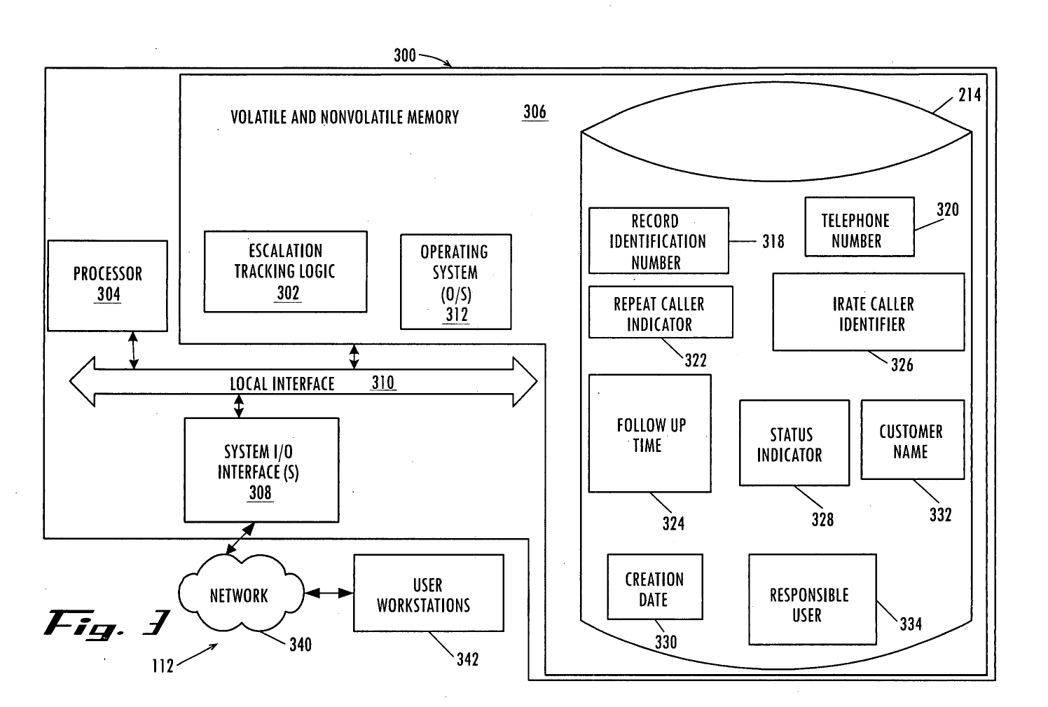

FIG. 2A provides a diagram showing how databases are conventionally accessed across a network. The database(s) 201 to be accessed is(are) connected to some type of network 203. The network 203 can be intranet, extranet, internet or any other network known to someone of ordinary skill in the art. A user workstation 205 is connected to the same network 203 allowing access to data in the database 201. Traditionally, a suite of software client services 207 must be downloaded and to the user's workstation 205 or otherwise installed to facilitate the access to the database 201.

FIG. 2B provides a diagram of one embodiment of the real time escalation system demonstrating how downloading and installing a suite of software client services 207, as is necessary in the system of FIG. 2A, can be avoided. In FIG. 2B, the same database 210 may be connected to same network 212 which may be connected to workstation 214. However, according to exemplary embodiments explained in further detail below, only an internet browser 208 (one example of a generic application such as Internet Explorer or Netscape) is needed to access the database 201 over the network 203. Instead of using a proprietary software package specifically tailored to accessing the escalation system, FIG. 2B provides an exemplary embodiment of a real time escalation system that can be accessed using many generic applications readily available to the general public. According to exemplary embodiments, there is no need for downloading or installing client software for accessing the database 201.

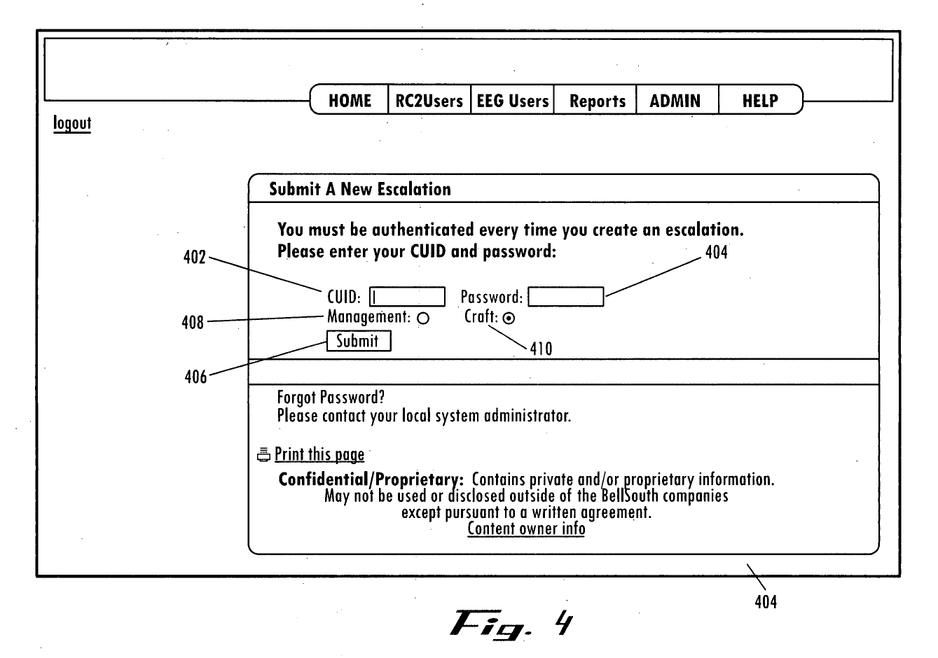

FIG. 3 is a block diagram depicting an exemplary embodiment of a computing device that can be used to implement the escalation system 112. Generally, in terms of hardware architecture, the escalation system 112 may include, inter alia, a server 300 connected through a network 340 to a plurality of user workstations 342, though other embodiments include standalone implementations. The server 300 may include a processor 304, memory 306, a local interface 210, and system input and/or output (I/O) interfaces 208. The server 300 may act as a web server and an email server. In an exemplary embodiment, the memory 306 is configured to include an operating system 312, escalation tracking logic 302, and tables 314. Microsoft Access™ is one example, among many others, of a software platform that can be utilized to provide the tables 314 and escalation tracking logic 302 to provide the functions discussed herein. The local interface 310 can be, for example but not limited to, one or more buses or other wired or wireless connections, as is known in the art. The local interface 310 may have additional elements, which are omitted for simplicity, such as controllers, buffers (caches), drivers, repeaters, and receivers, to enable communications. Further, the local interface 310 may include address, control, and/or data connections to enable appropriate communications among the aforementioned components.

The processing device 304 may be a hardware device for executing software, particularly that stored in memory 306. The processing device 304 can be implemented with any custom made or commercially available processor, a central processing unit (CPU), an auxiliary processor among several processors, a semiconductor based microprocessor (in the form of a microchip or chip set), a macroprocessor, or generally any device for executing software instructions.

The memory 306 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remote from one another, but can be accessed by the escalation system 112. The software and/or firmware in memory may include one or more separate programs, each of which comprises an ordered listing of executable instructions for implementing logical functions. Further, the software in memory can include a suitable operating system (O/S) 312. The operating system controls the execution of other computer programs, and provides scheduling, input-output control, file and data management, memory management, and communication control and related services.

When the escalation tracking logic 302 and tables 314 are implemented as a source program, then the program may be translated via a compiler, assembler, interpreter, or the like, which may or may not be included within the memory, so as to operate properly in connection with the O/S 312. Furthermore, the escalation tracking logic 302 and tables 314 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

When the escalation tracking logic 302 and tables 314 are implemented in software, they may be stored on any computer-readable medium for use by or in connection with any computer related system or method. The escalation tracking logic 302 and tables 314 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium.

When implemented as a hardware device for executing software, particularly that stored in memory, the escalation system 112 and tables 314 can include any custom made or commercially available processor, a central processing unit (CPU), an auxiliary processor among several processors, a semiconductor based microprocessor (in the form of a microchip or chip set), a macroprocessor, or generally any device for executing software instructions.

I/O devices (not shown) that may be connected to the system I/O interfaces 308 may include input devices, for example but not limited to, a keyboard, mouse, scanner, microphone, etc. Furthermore, the I/O devices may also include output devices, for example but not limited to, a printer, display, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If implemented in hardware, as in an alternative embodiment, the escalation tracking logic can be implemented with any or a combination of the following technologies, as one skilled in the art would recognize: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In an exemplary embodiment, data for the escalation system 112 is structured to include the plurality of tables 314 stored in memory 306 and accessible by the escalation tracking logic 302 and operating system 312. The escalation tracking logic 302 may be utilized to control data contained in the tables 314. In one embodiment, the plurality of tables 314 includes data such as record identification number 318, telephone number 320, repeat caller indicator 322, follow-up time 324, irate caller identifier 326, status indicator 328, customer name 332, creation date 330 and responsible user 334, among others.

According to an exemplary embodiment, the record identification number 318 includes the number assigned to a particular escalation record by the system 112. The telephone number 320 includes the phone number of the customer with the customer service issue. The repeat caller indicator 322 includes an indication of whether the customer has called before with a customer service issue. The follow-up time 324 includes a time within which a customer should receive a response to his or her customer service issue. The irate caller indicator 326 indicates whether the caller was angry when he or she called with an issue. An irate caller may entail a different escalation path or procedure. For instance, there may be some escalation team members that are better at diffusing explosive situations, and the record Could be directly forwarded to them.

The status indicator 328 indicates whether the case is opened or closed, having achieved the resolution. The customer name 332 includes the name of the customer who called with the customer service issue. The creation date 330 may be assigned by the system when the record is created, designating the date on which the record was created. The responsible user field 334 includes an indication of the user presently responsible for resolving the customer service issue and for closing the case. In an exemplary embodiment, the last name of the responsible user may be shown, except where duplicate last names exist, in which case a first name or initial would be included.

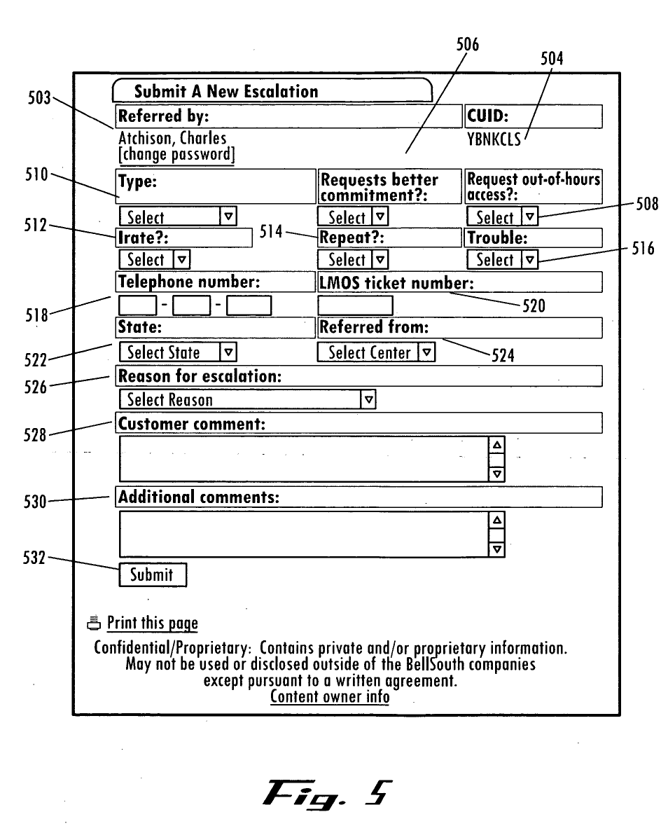

FIG. 4 is a block diagram depicting one embodiment of a display of an authorization screen 400 of an escalation tracking system 100. According to this embodiment, to access the escalation system a user must enter a valid user ID 402 shown in the figure as CUID and a corresponding password 404 which have been saved in the system. This exemplary embodiment, among others, also provides the ability to split the authentication procedure between multiple databases. In FIG. 4, the user may choose to be authenticated from the Management database 408 or from the Craft database 410. One possible enhancement enabled by this feature is to separate the accessibility granted to a particular user based on which database he or she is authenticated in. After the user enters the user ID 402 and the password 404, the user then clicks the submit button 406 to enter the system.

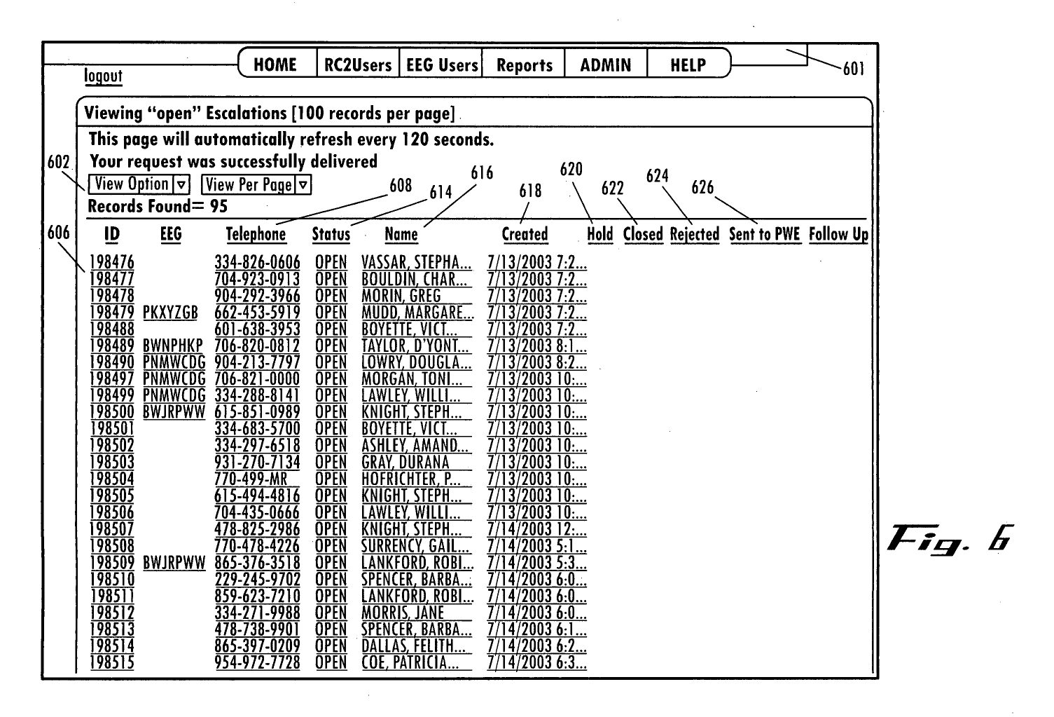

FIG. 5 is a block diagram depicting one embodiment of a display of a new escalation submission form. The form may include fields relevant to tracking most customer service issues. The fields may include the name of the user submitting the record 502, a link for changing a password 503, the user ID of the user 504, a field for indicating whether the customer was satisfied with their present level of service 506, an indicator whether the customer requested service after hours 508, a field for entering the type of issue 510, a field for entering an indication of whether the customer is irate 512, a field for indicating whether the customer is a repeat customer 514, a field for indicating the type of trouble found 516, a field for entering the customer telephone number 518, a field for linking this record to a legacy system 520, a field for indicating the state of the caller 522, a field indicating the referring party of the customer service issue 524, a field for indicating the reason for escalation 526, a field for the comments supplied by the customer 528, and a field for supplying comments by the user 530.

The party referring the customer service issue 502 may be in the form: “last name, first name.” This field provides other users who access this particular escalation record a contact person should they have any questions concerning the information in the record. The user ID 504 is the corresponding ID for the user entering the escalating record. The link for changing the password 503 leads to a screen which allows the user to change the password. The field for indicating if the customer requests better service 506 can be used as a indicator of a priority of this particular record. If a customer is unhappy and requires a better service commitment, then this field places the record as one of higher priority to be resolved. The out-of-hours access field 508 is an indication as to the availability of the customer and whether there is difficulty in resolving the issue. The field for the type of customer service issue 510 is used to indicate whether this is an escalation of a record or if this is for follow-up purposes only. The field for indicating whether the customer is a repeat customer 514 can be used to determine whether a particular customer is having several problems or if this is the first instance in which this customer has had an issue.

The field for indicating what type of trouble that the customer is having 516 indicates whether the trouble is of the nature of NDT (No Dial Tone), CCO (Can't Call Out), CBC (Can't Be Called), PHYS (PHYSical problem such as broken phone jack or cut wire), TRAN (TRANSmission problem such as static on the line), MEM (MEMory function such as call waiting or voice mail), or some other type of trouble among others.

The telephone number 518 is the ten digit telephone number of the customer with the customer service issue. The field for the linking record number from the legacy system 520 allows a company with a legacy system to link previous records to those in a newly implemented real time escalation system. If the legacy field 520 were not available, no information from that system would be able to be linked with that of the new system. The state field 522 is the state where the customer is located. The referred from field 520 may be the city location of the center that the customer called.

The reasons included in escalation field 526 could include such reasons as a medical emergency, a higher management complaint, a death in the family, a doctor on call, an outside plant, a hazardous condition, a field supervisor call back, chronic repeated report generator, and a buried service wire problem, among others.

The customer comment field 528 can be used to provide any comment provided by the customer such as: “My phone service is down,” or “There is noise on the line,” among others. The additional comment field 530 is required when some other reason for escalation has been selected or if the customer service user had some additional comments to make outside of those from the customer. This field is useful for situations which don't fit inside the constraints of the system as designed. When all the fields are correctly selected on the form, the user clicks on submit button 532. In an exemplary embodiment, there are some fields which are required to be entered. If the submit button is clicked without those required fields entered, an error will be generated, and the user is prompted to fill out those fields on the escalation record form. A required field may be indicated by a different color such as red as is commonly used. There may be other indications or methods of indicating which fields are required.

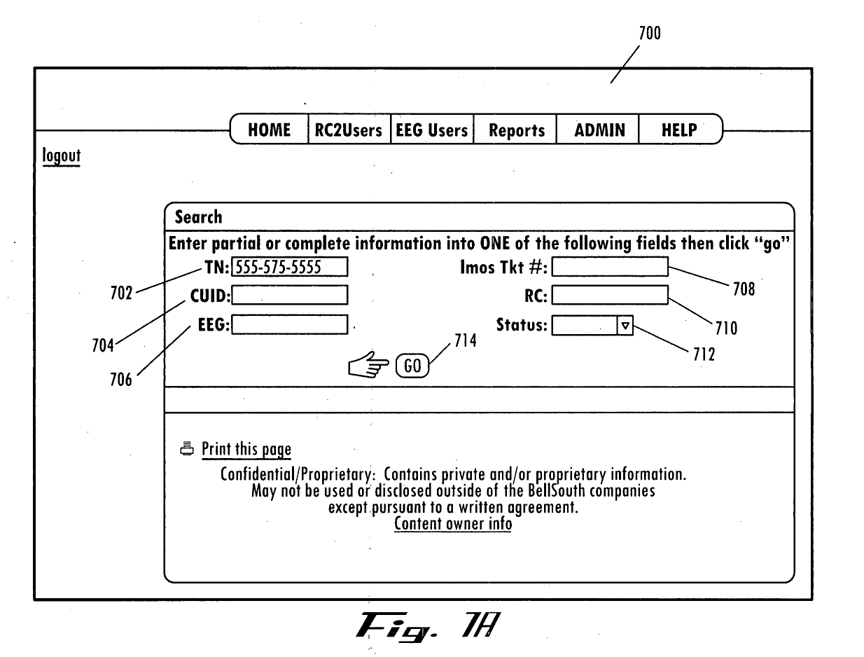

FIG. 6 is a block diagram depicting one embodiment of the display of open escalations 600 of an escalation tracking system 112. The open escalation form 600 is utilized by any user to view the records that are currently open in the system. An indicator that a record is open means that, in some respect, some further action is necessary to resolve the customer service issue. The fields shown are configured to be those which are most pertinent in assessing the workload and in locating one record in the list.

In one embodiment the form 600 includes sections for record ID number 606, a drop menu for viewing options 602, a drop down menu for a number of records viewed per page 604, the telephone number of the customer 608, an indicator of a repeat customer 610, an indication of an irate customer 612, an indication of the status of the record 614, the name of the customer 616, the date the record was created 618, an indicator that the case is on hold 620, an indication of whether the case is closed 622, an indication that the record was rejected 624, and an indication that the record has been sent to a PWE (POTS (Plain Old Telephone System) Web Escalation team member) 626, among others.

The ID field 606 is the field that was assigned by the system when the record was originated as demonstrated in FIG. 5. The telephone number 608 is the number as entered in the new record from FIG. 5. The repeat, irate, and status fields 610, 612, and 614 are populated with the information as entered in the FIG. 5, customer name 616, and the date created 618. The closed field 622, rejected field 624, and sent to PWE field 626 are populated on another screen which will be described hereinafter.

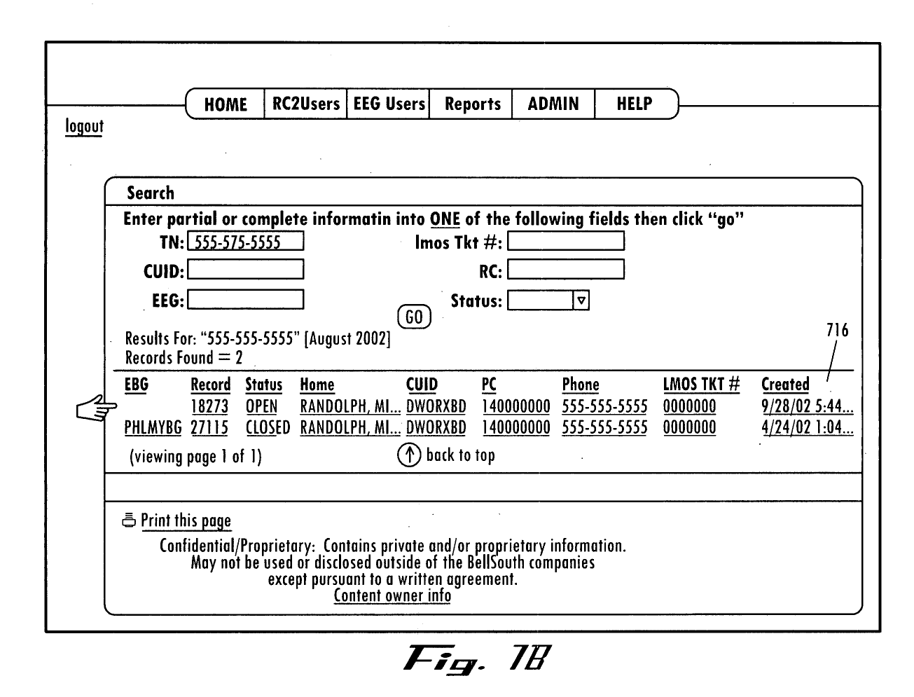

The view option drop down menu 602 and view per page drop down menu 604 from FIG. 6 are shown in more detail in FIG. 7. Options for the viewing options include selections for the cases which are opened 702, closed 704, on hold 706, assigned to PWE 708, rejected 710, or for viewing all cases 712, among others. The view per page drop down menu may include choices for the number of records to view per page such as 100 per page, 250 per page, 500 per page, and 750 records per page, among others.

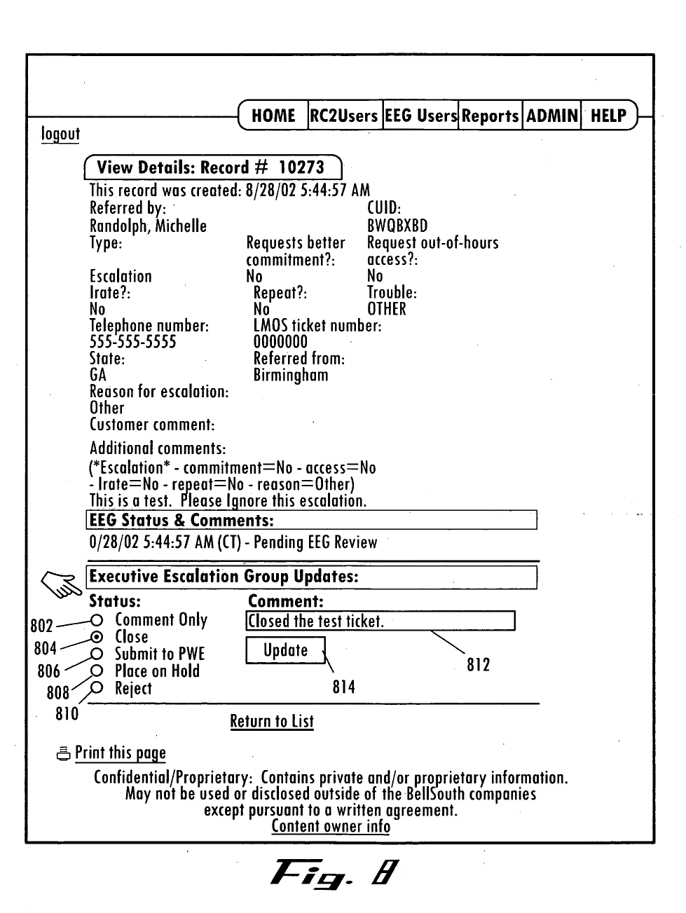

FIG. 8 is a block diagram depicting one embodiment of a record searching page 800 from which a user can search for records based on data in particular fields. One preferred embodiment includes search fields such as the telephone number 802, a user ID 804, the EEG ID 806, a legacy system ticket number 808, a repeat caller indicator 810, and case status 812. Each of these fields would have been entered into the record as shown in FIG. 5. After a user has filled in one or more of the fields, the user clicks the GO button 814. Other implementations of the GO button may be OK, SUBMIT, etc. One of ordinary skill in the art would know that the six fields shown are not the only fields for which a search may be performed. The fields may be searched. In one embodiment, upon clicking GO, the results for the search will appear on a screen as shown in FIG. 8B element 816, showing the number of records found for the fields that were searched in and the pertinent information for each of those records as shown previously in FIG. 6.

FIG. 8 is a diagram depicting one embodiment of the display of the available actions for a user on a submitted record. The actions available to the user include Comment Only 902, Close 904, Submit to PWE 906, Place on Hold 908, and Reject 910, among others. A Comment field 912 is also available to append comments with any of the selections. After the selection is made and, optionally, a comment has been entered, the update button 914 is clicked on to append the record being updated.

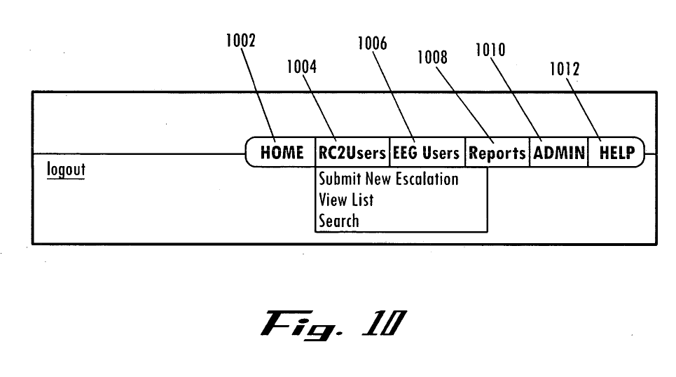

FIG. 10 is a block diagram depicting one embodiment of the display of the top navigational menu with the available options once access has been granted to a user. The buttons shown in FIG. 10 can either link to another page or provide a pull down menu for other options. In an exemplary embodiment, menus include Home 1002, RC2 users 1004, EEG Users 1006, Reports 1008, Admin 1010, and Help 1012, among others. RC2 users are the members of the group receiving the service calls and entering them into the system. They may also determine whether the record of the service call needs to be escalated and escalate the record to the EEG users who are the recipients of the escalated records, and who are responsible for ensuring that the customer issue has been resolved. The Home selection 1002 returns the user to the landing page. Selecting the RC2 User button 1004 presents a pulldown menu which includes the following options, among others: a user may submit a new escalation, view a list as shown in FIG. 7 which provides the detailed view of all escalations sorted by status, and Search as in FIG. 8A which allows the user to search for escalation records using multiple criteria.

The EEG User drop down menu 1006 includes an EEG Login option, a View list option, and a Search option, among others. The EEG Login option allows EEG Users to login and began working on escalated records, to post comments, and to update the status of a record. The EEG Login first requires an authorization to allow this function. The View List option provides a detailed view of all escalations sorted by status. The Search option allows the user to search for escalations using multiple criteria.

The Reports button 1008 allows access to all of the customer reports that have been generated. The Admin menu button 1010 allows application administrators to add user profiles, reset passwords, and alter other configurable site details. The Help button 1012 links to a text file that explains the operation of the escalation application.

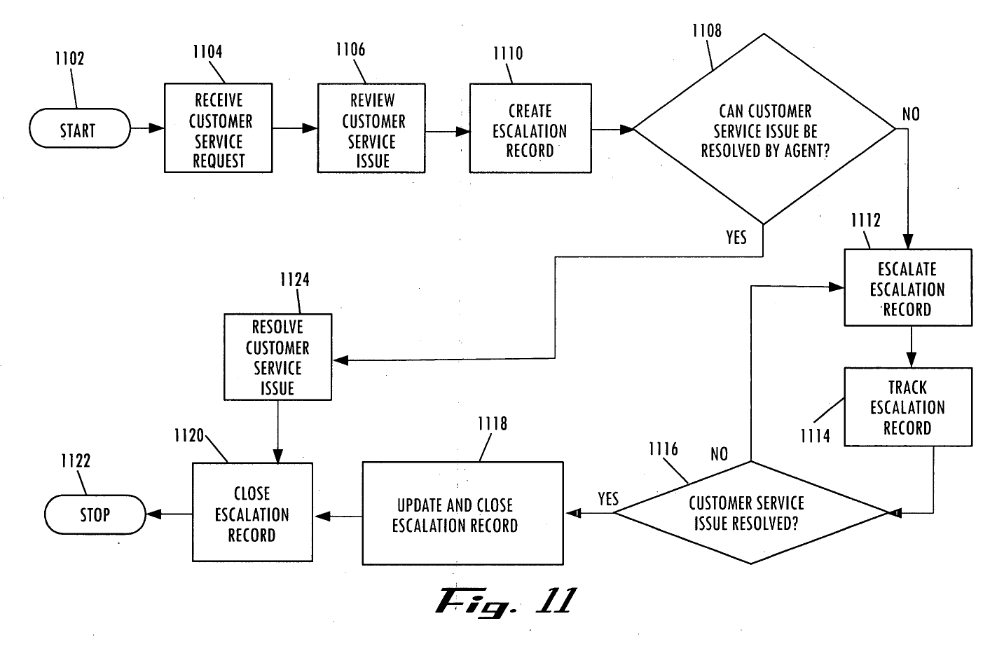

FIG. 11 is a flow chart depicting functionality in accordance with an exemplary embodiment of an implementation of an escalation tracking system. The process begins at 1102. At 1104, a customer service request is received. In an exemplary embodiment, a customer service representative responsible for resolving customer service issues receives the customer service request. At 1106 the representative reviews the issue. At 1110, the customer service representative creates a CSR. At 1108, a determination is made as to whether the representative can resolve the customer service issue. The representative examines the issue and determines the nature of the problem and the organization responsible for resolving the problem. Non-limiting examples of resolution steps taken by a representative include reviewing pending service orders and contacting appropriate personnel to resolve issues that the customer may see, arranging to disconnect or connect service as required on an order, or arranging for a field service representative to trouble shoot a service problem. If the representative determines that he or she is able to resolve the issue at 1124 the representative resolves the issue.

At 1120 the representative closes the customer service request. The process then ends at 1122. If the representative determines that he or she is unable to resolve the customer service issue at 1108, at 1112 an escalation occurs and the escalation record is created is forwarded to appropriate escalation managers for the resolution of the issue.

In an exemplary embodiment, an electronic mail (email) message is created by a server, like server 300, that includes the escalation record attached to the email message. The attachment may be in Microsoft Word™, for example. The email message is sent to the appropriate representative and the department responsible for resolving the issue.

At 1114, the escalation record created in the escalation system is tracked. In an exemplary embodiment, tracking the escalation record includes, for example, maintaining information about the escalation such as the status of the issue, contact information, and status of the escalation. At 1116, a determination is made as to whether the customer service issue has been resolved. If not, the escalation record is forwarded to the manager at 1112.

In an exemplary embodiment, the escalation record is escalated to the next level of representatives in the responsible organization for resolution. If the customer service issue is resolved, at 1118, the escalation record is updated and closed. At 1120 the customer service message is closed. The process ends at 1122.

It should be emphasized that the above-described embodiments of the present disclosure, and particularly any exemplary embodiments, are merely possible examples, among others, of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure.

1. A real time record escalation system comprising:
an interface for receiving records representing user requests collected from one or more individual workstations;
at least one database containing data related to user requests; and
a processing device configured for creating, maintaining, tracking and forwarding escalation records based on the received records representing user requests and the data contained in the database related to user requests, wherein the processing device provides an interface to create, maintain, track and forward escalation records for handling user requests using a generic application on individual workstations.

2. The system of claim 1, wherein the generic application is a web browser.

3. The system of claim 1, wherein the escalation records relate to customer service requests.

4. The system of claim 1, wherein the records representing user requests are received over the internet.

5. The system of claim 1, further comprising a display for displaying data included in the escalation records.

6. The system of claim 5, wherein the data in the escalation records comprises at least one of a record identification number, a telephone number, an indicator of whether a user is a repeat caller, an indicator of whether a user is irate, a follow-up time, a status indicator, a user name, a creation date, and an indicator of a user responsible for closing a record.

7. The system of claim 1, wherein the data is displayed on at least a first screen and a second screen.

8. The system of claim 7, wherein the first screen provides a summary of the data, and the second screen detailed data.

9. The system of claim 5, wherein the data further comprises a summary of trouble that a user has experienced.

10. The system of claim 9, wherein the data further comprises at least one of an indicator of whether a customer is requesting better commitment, an indicator of whether a customer is requesting out-of-hours access, a reason for escalation, customer comments, or user comments.

11. A method for escalating records on an internet architecture comprising:
receiving records in a database, the records representing user requests collected from one or more individual workstations and
creating escalation records based on the received records representing user requests;
maintaining the escalation records;
tracking the escalation records;
forwarding the escalation records; and
an interface for creating, maintaining, tracking, and forwarding escalation records using a generic web browser application on individual workstations.

12. The method of claim 11, wherein the generic application is a web browser.

13. The method of claim 11, further comprising modifying the escalation record.

14. The method of claim 11, further comprising determining whether the escalation record requires escalation for resolution.

15. The method of claim 14, further comprising:
modifying the escalation record upon determination that a record requires escalating; and
changing responsibility for closing the record.

16. The method of claim 15, further comprising closing the escalation record when a resolution is achieved.

17. The method of claim 11, further comprising authenticating a user.

18. The method of claim 16, wherein authenticating comprises matching a user ID and a corresponding password.

19. The method of claim 11, further comprising locking the record wherein only the user locking the record has access to modify the record.

20. The method of claim 13, further comprising time-stamping the modifications of the record.

21. The method of claim 13, further comprising marking each modification with the user ID of the user making the modification.

22. A computer readable medium for storing instructions for performing a method for real time escalation of records, comprising:
logic configured to receive records in a database, the records representing user requests collected from one or more individual workstations; and
logic configured to create escalation records based on the received records representing user requests, wherein the logic configured to create escalation records is configured to use a generic web browser application on individual workstations.

23. The computer readable medium of claim 22, wherein the generic application is a web browser.

24. The computer readable medium of claim 22, further comprising logic configured to maintain the escalation record.

25. The computer readable medium of claim 24, further comprising logic configured to track the escalation record.

26. The computer readable medium of claim 24, further comprising logic configured to forward the escalation record.

27. The computer readable medium of claim 26, further comprising logic configured to modify the escalation record.
